(19) United States
(12) Patent Application Publication
(10) Pub. No.: US 2008/0027772 A1
(43) Pub. Date: Jan. 31, 2008

(54) SYSTEM AND METHOD FOR OPTIMIZING A TRANSIT NETWORK

(76) Inventors: Boris GERNEGA, Maple (CA); Ian KEAVENY, Burlington (GB); Vlodomir CHERNENKO, Toronto (CA); Dragan ZUGIC, Mississauga (CA); Brad HEIDE, Mississauga (CA)

Correspondence Address: LANG MICHENER, BCE PLACE, P.O. BOX 747, SUITE 2500, 181 BAY STREET, TORONTO, ON, M5J 2T7, US

(21) Appl. No.: 11/779,726

(22) Filed: Jul. 18, 2007

(30) Foreign Application Priority Data
Jul. 31, 2006 (CA) 2,554,651

(51) Int. Cl. G06Q 10/00

(52) U.S. Cl. 705/7

(57) ABSTRACT

The present invention consists of a system for optimizing the operation of a transit network, where the transit network including one or more transit operators, each of the transit operators providing one or more transit vehicles, including: ferries, trains, elevated trains, subways, buses, streetcars, vans and taxis. The system is comprised of a) a data collection component adapted to collect data from said transit operators and said transit vehicles; b) a data processing component adapted to process said data to determine viable routing options within said transit network for a passenger to travel from a start point to an end point within said transit network; c) an algorithm for assessing said viable routing options to determine a routing option that minimizes one or more of: fare, time, travel distance, transfers, distance from the start point to entry onto the transit network; distance from the end point to entry onto the transit network or any other passenger-input criteria; and d) a data display component for presenting the routing option so determined to the passenger.

### FIELD OF THE INVENTION

The present invention relates to the field of transit networks. In particular, it relates to a system for optimizing the combination of vehicles, geographic regions and financial sources that comprise the transit network and a method of using the same.

### BACKGROUND OF THE INVENTION

The majority of large cities have a public transit network for alleviating the traffic flow created by passenger vehicles. As cities increase in size, the number of passengers and transit vehicles on the network increases as well. Over time, the efficiency of the transit network can begin to suffer if the elements of the network are not properly optimized, in particular the determination of transit routes and allocation of drivers and vehicles to these routes. Furthermore, with the demand for increased transit use as a means of reducing pollution and environmental damage from single-passenger vehicles the need to optimize transit networks is greater now than ever before.

One of the objectives in providing a public transit system is to minimize the social and economic impact created by the transportation demands of the population of a city of any size. Particularly in North America, the population continues to rely heavily on individual automobiles for transportation, and the change to widespread use of public (mass) transit has been slow in coming. As a result, major metropolitan areas, such as Los Angeles, Calif. and Toronto, Ontario, find themselves dealing with a serious two-pronged issue of pollution and traffic congestion before even considering the socio-economic impact of institutionalized automobile use.

The continued reliance on individual automobiles has hindered progress in addressing the environmental issues created by these vehicles. Currently, the vast majority of automobiles operate on gasoline-powered internal combustion engines, which produce measurable amounts of airborne pollutants while operating. These airborne pollutants, besides creating air pollution and its associated problems, also create water pollution as they are removed from the atmosphere. In addition, spillage and leakage of the fuels and lubricants used in these engines leads to soil and water pollution.

In addition to environmental issues raised by the use of individual automobiles, there are also socio-economic issues. In the absence of available public transit, many people and families are effectively forced to own and use at least one automobile, and often two or three, if they can afford to do so. The cost of even a single automobile becomes a substantial financial burden when the totals costs of financing, fuel, insurance, maintenance, repair and parking are factored in. Also, the costs of maintaining the road and highway infrastructure to meet the demands of the volume of automobile traffic using these roads and highways represent a major public expense, whose cost is passed on to individuals in the form of taxes and tolls.

As another result of the widespread use of individual automobiles, the development of infrastructure necessary for a successful public transit system is inhibited. The parking requirements for users of retail and commercial building space often limit accessibility by public transit. In low density urban and suburban areas where individual automobiles are most common, this problem is greater, making public transit less efficient and useful in those areas where it would be of the greatest benefit.

Conventional public transit systems include buses operating on fixed routes, as well as one or both of light rail systems and regular rail systems, possibly including an elevated train or subway system. Rail systems often have a large ridership in areas with a high population density, however, the costs of purchasing land and constructing tracks tend to prohibit expansion of these systems on a wider scale. In addition, rail systems that service areas of lower population density, such as suburban-downtown commuter trains, are incomplete solutions as the users are still required to travel to and from the rail stations to their final destinations.

Using buses to fill the endpoint gaps in the rail systems, as well as providing conventional bus service, partially alleviates this problem. Unfortunately, buses suffer from the limitation of operating on the same roads and highways that are used by individual automobiles, making scheduling and adhering to schedules very difficult. Also, buses contribute somewhat to existing traffic problems when operating in high-traffic areas due to their size and operating characteristics. Another problem in areas with a low population density is that stop locations are often widely spaced and may not be conveniently accessed by all potential users. Coordinating transfers, especially where the user is changing between vehicles operated by different transit operators, is another problem.

The result is that currently the majority of the population do not use public transit as it does not present an efficient solution to their transportation needs. Although public transit is less expensive, sometimes substantially, than an automobile, the inconveniences and inefficiencies in access and scheduling prevent many potential users from considering public transit as an option.

One potential solution is automation. Over the past two decades, transit agencies have made substantial investments in automating many of their fixed route functions, including scheduling, operations, passenger information, mapping, and ridership data gathering. While each of these automation initiatives has produced substantial value in its own right, collectively they have created a vast amount of data, much of which is stored and used in disparate parts of the organization. As many agencies struggle with the conflicting demands of a growing population and declining finding, the need to manage data to come up with workable, long-term solutions has become more and more important.

In the face of shrinking budgets and growing demand for public transportation, transit agencies are struggling to find every possible efficiency and incremental productivity increase to stretch their resources. Accordingly there is an ever-increasing requirement to analyze and report on ridership, performance and other metrics at the local, state/provincial and federal levels. Agencies seeking capital and operating funds also must provide more and more detailed reports about their operations, plans and needs than ever before. Technologies developed in the past 20 years have made some of this easier—computerized scheduling, mobile computing and geographical information systems can all generate the data necessary to find more efficient ways to operate, and to inform funding agencies about where their transit dollars are being spent.

Transit companies are now able to use advanced Geographical Information Systems (GIS) software applications that can perform complex spatial and statistical analyses needed to synthesize disparate data into a meaningful context. GIS requires a high level of technical knowledge that may not be available to many agencies. Such organizations have a need for tools to manage their data or lose its value.

Regardless of their size or the degree to which they are automated, all transit agencies have internal data: schedule and route data, passenger counts, farebox information, bus stop inventories, vehicle location data all exist, usually in different parts of the organization. Some or all of them may be in databases, or in thick paper files or simply in the heads of the planning, scheduling and operations staff.

External data are also ubiquitous: Census information, school enrollments, maps, employment statistics, welfare rolls, and other third-party data. Additional region or country specific data, such as ADA (Americans with Disabilities Act) zones in the United States, may also be included. A system is needed to collect and analyze all of this data to serve the community, save money, inform funding requests, comply with regulations and support decision-making at the senior transit management level.

Another problem is that for true optimization of a transit network all the potential network considerations must be factored in. To date, optimization methods have focused on one particular consideration or another, deeming the whole to be too complex or contain unnecessary considerations.

The first consideration is the types of vehicles used in the transit network. The transit network may consist of a single type of vehicle traditionally associated with transit, such as buses or a subway. Or the network may consist of more specialized or regional vehicles, such as ferries, streetcars and vans. Most often, a transit network will have some combination of different vehicles. Each type of vehicle has its own separate requirements, not only in conventional terms of fuel, maintenance and passenger capacity, but also types of routes (fixed or variable), number of vehicles available at one time and accessibility (e.g. subway/train stations, bus stops). As a result, any system of optimizing the transit network must be able to factor in all available types of vehicles, as well as allow for the addition of new types of vehicles when introduced.

The second consideration is the geographical region or regions serviced by the transit network. A small network may be restricted to a single city or municipal region. Larger networks may link several municipal regions (i.e. a metro area for a city) or even several cities. The largest networks may still further include inter-city, inter-state and even inter-country transit services. The optimization system must account for many different restrictions for each region and identify any parts of the network that cross regions.

The final consideration is funding. While most transit operators collect fares from riders, the majority are also subsidized by one or more levels of government. In addition, some transit operators may include privately funded, such as by advertising, or charitably funded networks within the larger whole. Again, the optimization system must account for these funding elements in determining such factors as passenger eligibility and minimum fares for routes. Additionally, rider tracking should be included for proper reporting as part of the optimization process.

Many transit planning departments are well-equipped to gather data for these considerations; however, very few have the tools needed to analyze the data so as to optimize their operations. An example is in the area of forecasting demand. Demand forecasts build on the demographic and location data to extrapolate future trends. Using census data it is fairly straightforward to forecast population growth, the make-up of a given area and the economic conditions that might prevail in two, five or ten years' time. What is much harder to do is to apply this information to the task of transporting people. Variables that can have a profound impact on transit use include fares, service frequency, length of trip and the propensity of a given group (e.g. vehicle owners) to use transit in the first place. AVL (Automated Vehicle Location) and APC (Automatic Passenger Counter) data can play a large role in this area. Both of these technologies represent significant opportunities to capture valuable data, particularly once integrated into a proper optimization system.

Furthermore, many transit systems have automated transit information systems, many of which offer itinerary planning through web or IVR (Interactive Voice Recognition) interfaces. Data from these interfaces is combined with trip planning data from agent-attended call centers, which also offers a rich source of planning data. By analyzing which origins and destinations have resulted in failed itinerary requests, it is fairly easy to identify areas in need of better services. Good planning tools should be able to import this data directly from the customer information or scheduling databases to avoid errors and the costs of re-entering the data.

Spatial analysis can be used to help synthesize the statistics and apply them in the real world. Spatial data describe features such as a census tract, a bus stop or a fixed bus route in terms of its geographical location (longitude and latitude coordinates). A GIS tool is able to use these spatial data to illustrate the relationships between features, usually on a map. For example, a GIS can help analyze census data in relation to a bus route to show the number of people who do not own vehicles that could be served by that route. Taking it a step further, a GIS can extrapolate the proximity of a given group of people to a feature. An example might be the number of school age children who live within a half mile of a bus stop, or the number of ADA-eligible passengers who must travel from one area of the city to a particular dialysis clinic. Using spatial data, a GIS tool can produce valuable information such as walking distances, intermodal overlaps, under-served or over-served neighborhoods by looking at routing and customer information data from a variety of systems.

The visual nature of spatial data analysis makes it much easier to work with vast amounts of information and to quickly see patterns, redundancies, gaps and inefficiencies. The problem with many GIS tools, particularly for smaller agencies, is that they require advanced spatial and statistical analysis skills that may not be available or affordable.

There are, of course, data that cannot be analyzed spatially, including temporal information such as schedules, work and pay rules and budgets. An optimization system must be able to join both spatial and statistical data to produce meaningful analyses, and to become part of an agency's corporate intelligence.

While primitive GIS planning systems have existed in one form or another since the mid-1960s, and in the past ten years have come into widespread use in a number of industries, particularly forestry, mining, agriculture and other land-intensive activities, a multinodal, multiregional GIS-based system for optimizing a transit network does not exist.

Another aspect to consider is that automated traveler information systems have become one of the primary tools for transit operators seeking to increase ridership and improve customer satisfaction. In the past five years, a number of new technologies have made the development of such systems more affordable and more feasible for most agencies. Solutions in use range from downloadable system maps on transit web sites to wireless trip planning services to bus arrival countdown systems at the stop level. While the vast majority of larger agencies, and a compelling number of smaller organizations are embracing passenger information services, very few are doing so at the regional level.

For the past few years, regional governments and transit agencies have been making substantial investments in producing travel information in an effort to boost ridership and improve passenger satisfaction. From producing better travel guides to posting bus-stop level schedules to arming call center representatives with printed maps and headway books, the past 25 years has seen gradual improvement to the ways in which transit agencies communicate with their riders.

Despite this progress, studies have shown that the perceived or actual difficulty of obtaining information remains a key impediment to wider use of transit services. Poor information accessibility poses a barrier to public transport use that is as serious as physical access barriers. In response to this, many transit agencies have made the deployment of automated travel information services a priority.

For public transit, such services include a number of technology solutions that help passengers make better decisions about how and when they travel. Information available through such systems typically includes service areas and routes, scheduled departure times, transfers, fares, general information and links to other transportation services. Automated travel information systems can deliver the information through a variety of media including interactive telephone information systems (IVR), Internet-based systems, terminal and wayside information centers, kiosks, and in-vehicle display and annunciator systems.

What is needed, in addition to providing route maps, schedules and other service information, is the implementation of automated trip planning services. These automated services should augment or replace those conventionally provided by call center staff, who traditionally relied on printed materials such as route maps and headway books. The first step to automating passenger information services involves developing transit databases and software that call center representatives can use to help passengers develop travel itineraries, determine fares and minimize walking or transfers. Based on one or more parameters such as a starting point, destination, target departure or arrival time, these services should provide passengers with detailed itineraries optimized for travel time, walking distances, number of transfers and fares.

Advancements in technology have made information services more affordable for small and medium agencies to implement. Initially installed at the call center and accessible only to customer service representatives, some agencies have since introduced Internet-based pre-trip information systems, enabling passengers to interact directly with the software via a Web browser. Inroads have also been made into providing trip planning using IVR technology. The net effect of these different interfaces has been to make travel information more accessible to current and potential transit users. This in turn is believed to facilitate wider use of public transit. These technologies also greatly reduce call center volumes, hours of operation and staffing requirements, producing cost savings that, over time, recover the technology investment in alternative channels.

Despite better-informed riders and the ability to push detailed information through a variety of channels, agencies are still facing pressure from government to improve mobility, reduce urban congestion and run more efficient systems. There are many cultural and economic reasons behind lack of transit use, but one key means of promoting the use of public transportation is by developing integrated transit networks. The fact is that transit users frequently need to use multiple transit operators as they travel to and from offices, shopping centers, restaurants, medical centers, recreation facilities and other destinations.

The likelihood of using more than one operator increases significantly as passengers cross municipal and regional boundaries in the course of their travels. As metropolitan areas continue to expand, public transit travel between municipal areas will increase. Adjacent municipalities and providers with overlapping service areas need to ensure that passengers can access all the travel information they require from a single source. Regional solutions offer agencies the opportunity to share resources and reduce the overhead of implementing such a system on their own. Automated services that let customers interact directly with the system through a web interface, kiosk or IVR system, could substantially reduce call center costs.

Technological challenges arise out of the need to build an integrated solution from disparate parts. In a given group of agencies, the differences in size, scope, budget and service mean substantial differences in IT environments, routing and scheduling applications and the ways in which customer information is generated. These systems could range from sophisticated infrastructures with integrated databases, GIS mapping and fully-automated routing, scheduling and dispatch to manual, paper-based or semi-automated processes with only basic IT resources.

To further complicate matters, while many larger operators maintain detailed information about the vehicles, routes, and bus stops, smaller operators may have this data only on paper, if at all. Similarly, scheduling databases will differ from one operator to the next, and may not exist in organizations that schedule manually. An information system must be designed to accommodate many disparate operational and technological environments; the software cannot impose a single solution on agencies with different characteristics, nor should it matter what kind of scheduling and mapping software the data come from. The flexibility to maintain and access data in different formats is essential. The system must also enable service providers to develop a regional architecture that best suits their operational characteristics and existing technology infrastructures.

A typical public transit operator (PTO) will have implemented some form of passenger information system that may or may not include schedules, fares or trip planning. However, with no integration of data and services, these systems do not “talk” to one another, and it falls to the passenger to determine how the services connect and when and where transfers between the services take place. Single agency services offer the advantages of great flexibility, local control, easy security setup and lower communications costs; however, hardware, software, support and administration costs will be higher for each agency. Furthermore, PTOs miss out on the opportunity to participate in a regional transportation network, and smaller services may lack the resources to extend their delivery beyond a basic call center.

In contrast, transportation networks are a thoroughly centralized solution, in which one agency delivers schedule and fare information and trip planning for the region. Individual operators are responsible only for providing up-to-date data to the central server. This centralized configuration is more cost-efficient than the distributed system as it eliminates multiple infrastructure costs such as telecommunications equipment and office space.

There is a need for a transit network optimization system that is capable of taking all the above considerations as input and producing optimized results for determining transit routes as well as vehicle and driver allocation. The system should further be able to respond to passenger inquires and provide an optimized itinerary based on passenger-selected criteria.

### SUMMARY OF THE INVENTION

One aspect of the present invention consists of a system for optimizing the operation of a transit network, where the transit network including one or more transit operators, each of the transit operators providing one or more transit vehicles, including: ferries, trains, elevated trains, subways, buses, streetcars, vans and taxis. The system is comprised of a) a data collection component adapted to collect data from said transit operators and said transit vehicles; b) a data processing component adapted to process said data to determine viable routing options within said transit network for a passenger to travel from a start point to an end point within said transit network; c) an algorithm for assessing said viable routing options to determine a routing option that minimizes one or more of: fare, time, travel distance, transfers, distance from the start point to entry onto the transit network; distance from the end point to entry onto the transit network or any other passenger-input criteria; and d) a data display component for presenting the routing option so determined to the passenger.

Another aspect of the present invention consists of a method of optimizing the operation of a transit network utilizing the system. The method comprises the steps of: a) collecting data from said transit operators and said transit vehicles; b) processing said data to determine viable routing options within said transit network for a passenger to travel from a start point to an end point within said one or more transit networks; c) analyzing said viable routing options to determine a routing option that minimizes one or more of: fare, time, travel distance, transfers, distance from the start point to entry onto the transit network; distance from the end point to entry onto the transit network or any other passenger-input criteria; and d) presenting the routing option so determined to the passenger.

Other and further advantages and features of the invention will be apparent to those skilled in the art from the following detailed description thereof, taken in conjunction with the accompanying drawings.

### BRIEF DESCRIPTION OF THE DRAWINGS

The invention will now be described in more detail, by way of example only, with reference to the accompanying drawings, in which like numbers refer to like elements, wherein:

FIG. 1 is a prior art diagram of the information retrieval system for a transit operator;

FIG. 2 is a prior art diagram of the information retrieval system for a transit network;

FIG. 3 is a diagram of the information retrieval network for a transit operator using the optimization system of the present invention;

FIG. 4 is a diagram of the information retrieval network for a transit network using the optimization system;

FIG. 5 is a diagram of the modules within the optimization system;

FIG. 6 is a route diagram for a transit network; and

FIG. 7 is a route diagram for a transit network indicating a specific route.

### DETAILED DESCRIPTION OF THE PREFERRED EMBODIMENTS

The invention consists of an optimization process that unifies three disparate elements of a transit network: vehicles and routes, geographic and demographic regions and funding sources. The data most transit agencies use comes from a variety of internal sources including: schedule databases, automatic passenger counting applications (APC), automatic vehicle location systems (AVL), customer information centers including automated voice systems (IVR) and web-based services, electronic faring ridership surveys, random ride checks, and bus stop databases. External data sources include: census data, map files, National Transit Database information, employment statistics, land use data, school enrolment, ADA clients, and welfare recipients.

This data is relevant to three key areas of transit agency performance: schedule and route adherence and ridership analysis; demographic and location analysis (which portions of the population are or are not being served by transit and what parts of the service area are adequately covered); and demand forecasting (ridership growth and financial planning).

### Diagrams

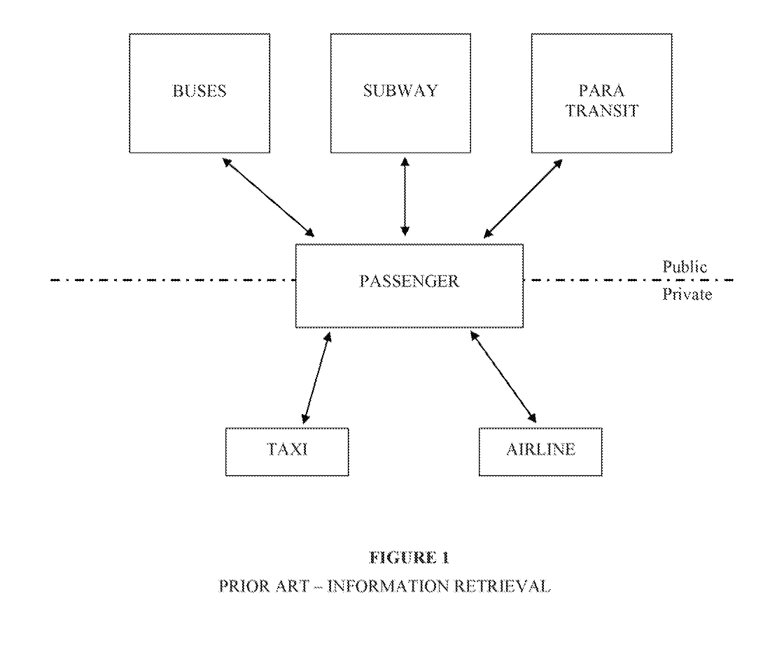

In the prior art, the passenger is the center of the information/data flow as shown in FIG. 1. Each public transit type e.g. buses, subway, paratransit has its own data transfer to/from the passenger. Similarly, private transit types e.g. taxi, airline has a separate data transfer. Thus, while information passes from the bus service (i.e. routes, schedules, fare prices) to the passenger, information from the subway service (stop locations, schedule, fare prices) requires a separate request. Furthermore, the onus falls on the passenger to combine and assess the information from the two sources, which may be in substantially different formats.

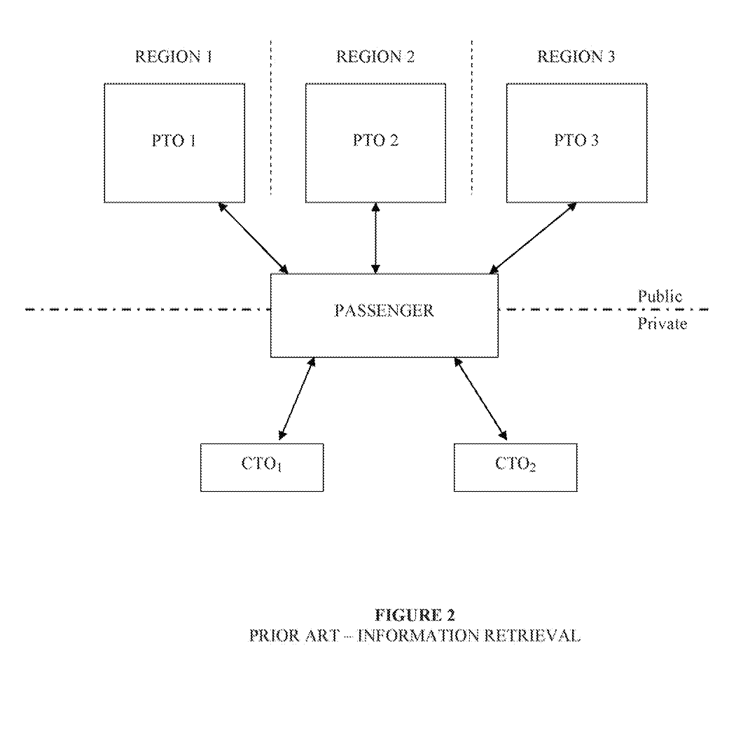

On a larger scale, the information/data flow continues to operate in the same way. For multiple regions, as shown in FIG. 2, the passenger must separately request information from public transit operators (PTOs) in each region, as well as commercial transit operators (CTOs). The difficulties for the passenger are now compounded as each region then breaks down into the different services as shown in FIG. 1.

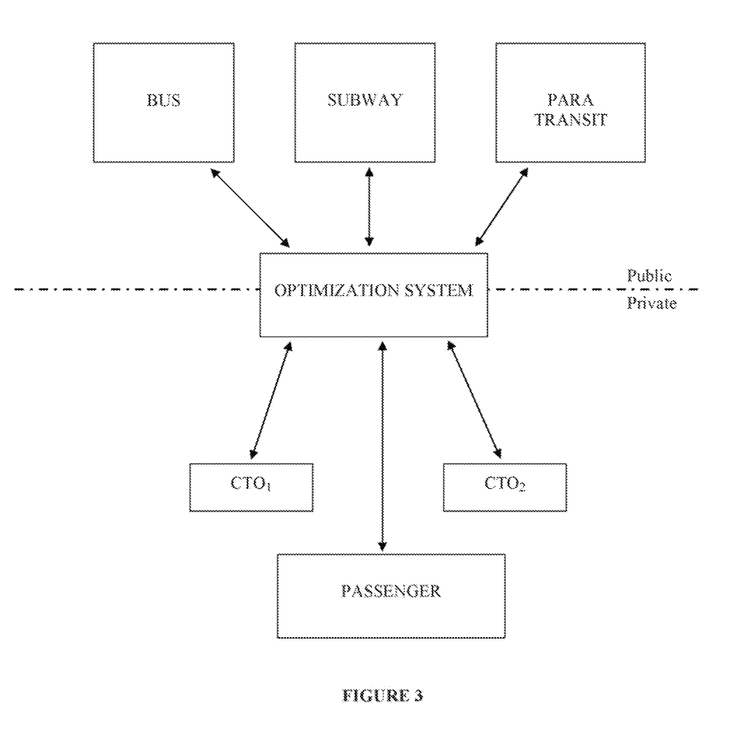

The optimization system of the present invention acts as an information hub as shown in FIG. 3, effectively replacing the passenger at the center of the information network. Data from the different public transit services and commercial transit services flows in and out of the optimization system. Now, when a passenger makes a request, it is handled by the system, which provides all the data for all the services in one request and in a common format. As a result, the ability of the passenger to assess the information and make an informed decision about transit use is greatly simplified.

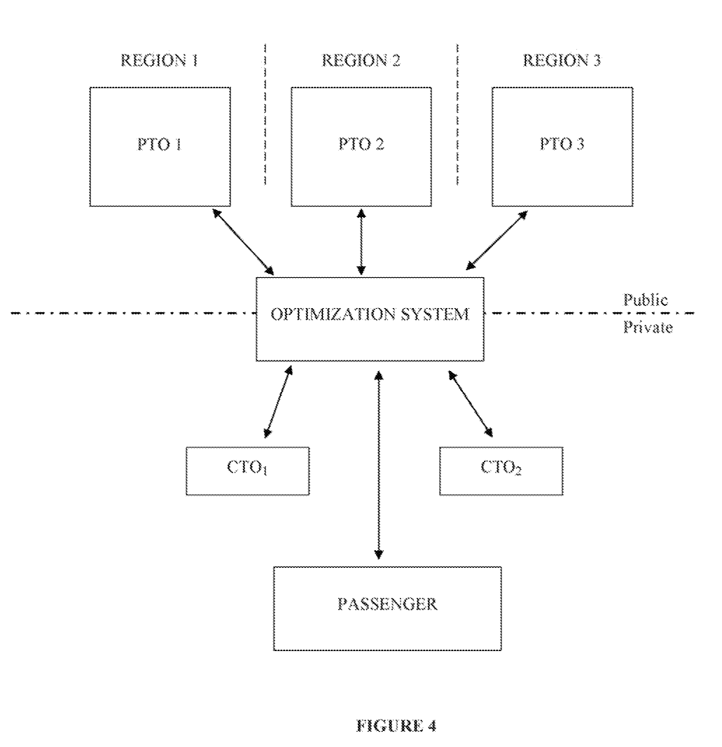

The optimization system is scalable, as shown in FIG. 4, to perform the same data collection and transfer handling for a multi-region transit network. Data from the PTOs in each region, as well as the CTOs, is collected by the optimization system, making the information for all regions available from a single source. Significantly, the system can, if necessary, perform this function without any additional communication between the PTOs.

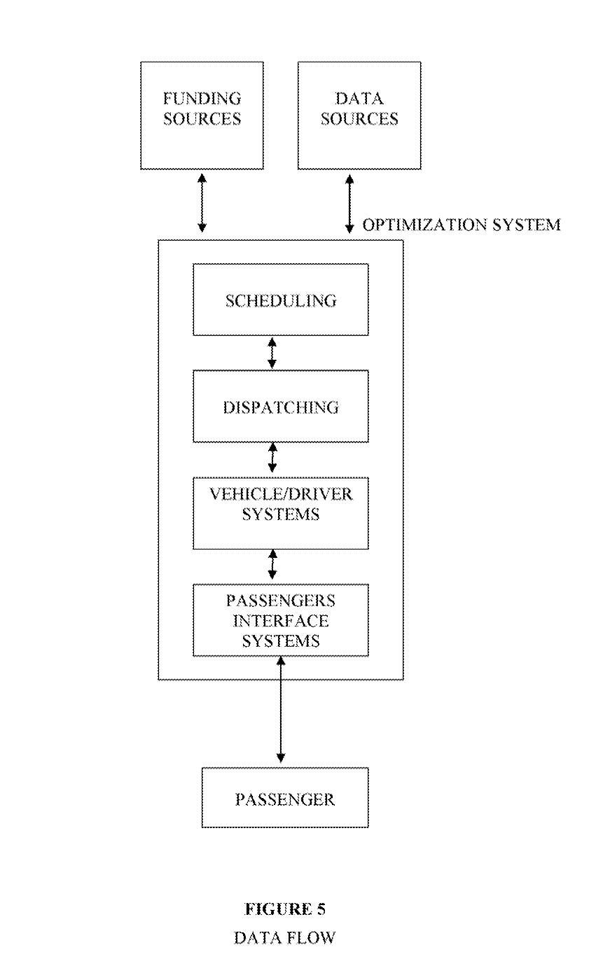

The optimization system is composed of different modules as shown in FIG. 5 for handling the various tasks required to operate a transit network. The modules can generally be categorized into four types: scheduling, dispatching, vehicle/driver systems and passenger interface systems.

The scheduling module contains all the route and stop information for the network. Locations for bus stops, subway stops, train stops, arrival/departure times and maps of bus and subway routes are all contained within the module. The scheduling module is further capable of analyzing the route and stop data to identify stops with unusually high or low use and suggest modifications to route and stops for optimized passenger capacity and/or ridership.

The dispatching module contains the driver and vehicle availability list, driver assignment and work schedules, and safety and labor (i.e. union contract terms) requirements. The dispatching module takes in the schedule data from the scheduling module and combines it with the dispatching data to create an assignment schedule assigning vehicles to routes and drivers to vehicles. The dispatching module is further capable of handling any other related tasks, including employee payroll records and vehicle maintenance tracking.

The vehicle/driver systems module contains all the data gathered by on-board vehicle equipment for each vehicle and its associated driver. Types of on-board vehicle equipment used include AVL, APC, electronic fare collection, GPS locators, idle monitoring systems, vehicle status monitors and emergency/alarm systems. The module is thus able to provide up-to-date status reports on request, as well as automatically generate alerts and notifications. These alerts can include providing a notice to passengers that a vehicle is running ahead or behind schedule or advising maintenance personnel that a vehicle is incoming for an oil change.

The last module is the passenger interface module. The module contains all of the interfaces used for communicating with passengers. These interfaces typically include a call-center, IVR systems, a website, kiosk or in-vehicle information system for passengers to make route inquires, received optimized route data and report complaints or incidents.

The division into modules presented herein is for ease of presentation and to more accurately reflect the categories of tasks performed by the optimization system. However, in a practical application, there will be many modules handling various specialized tasks that are integrated into the whole system.

### Vehicles and Routes

The first aspect for optimization is assessment of the number and types of vehicles available on the transit network. This assessment then leads into the determination of available routes. From there, optimal route planning for single passengers, multiple passenger groups and the network as a whole can take place in conjunction with geographic and financial considerations.

Vehicles can be split into two initial types: fixed and variable. Fixed vehicles generally have their routes defined by geography, such as ferries and planes, or by physical requirements (i.e. tracks) such as trains, elevated trains, subways and streetcars. Variable vehicles are generally only limited by the restrictions of available roads and include vehicles such as buses, mini-buses, vans, and taxis. This division of vehicle types is useful for optimization, as changes for variable vehicles (i.e. changing the locations of bus stops) are much more readily accomplished than changes for fixed vehicles (i.e. building a new subway or train station).

While the distinction is made for optimization purposes, the classification as a “variable vehicle” does not preclude the vehicles from operating on a fixed route, like buses stopping at bus stops on a pre-determined route and a “fixed vehicle” may operate on a variable route by omitting stops, like express commuter trains. For most purposes, transit networks use fixed routes for passengers, regardless of vehicle type. However, some transit networks include special networks (herein called “paratransit”) for people with disabilities or other restrictions. These paratransit networks typically use variable routes and lower-capacity variable vehicles, particularly mini-buses and vans.

Most transit operators use a combination of fixed vehicle and variable vehicle services. Furthermore, many passengers may be required to switch vehicles at some point during their journey. For example, a passenger may begin a trip on a commuter train, transfer to a subway, and then take a streetcar or bus to their final destination, with the additional possibility of walking from transfer to transfer, as well as from the bus stop to the final destination point. The optimization system needs to consider the various transfer points and vehicle switches that may be required to travel between any two destinations within the scope of the network.

Another factor is expansion. Most transit operators are constantly evolving, whether by adding new vehicles, building new tracks and stations, or even adding completely new services to the network. The optimization process needs to be able to consider these possibilities when put before it. The impact of a proposed expansion, whether through construction or incorporation of existing adjoining transit networks, should be capable of being assessed by the optimization process.

As an example of the scope of vehicles and routes available in a typical transit operator, the city of Vancouver, Canada has a transit system consisting of a multi-stop single route commuter train, a point-to-point ferry, a multi-stop, multi-route elevated train (SkyTrain™) and a conventional bus system, along with a paratransit network of mini-buses and vans.

Additionally, many public transit operators are required to report on passenger miles, route productivity and performance. Data for such reports come from several sources, including the scheduling database; mobile technologies such as AVL or on-board mobile data terminals (MDTs); APC and electronic faring. The optimization process can be used to correlate this data, preferably using a GIS planning application wherever applicable. At the bus stop level, for example, it is possible to determine the most and least used stops on a route, the number of boardings and alightings at each stop and to compare that with amenities such as benches or shelters. This allows stops to be sited more conveniently and to place the amenities where they are most needed.

Ridership analysis is also essential to understanding the overall performance of a transit system. It allows for the identification of the busiest and least busy trips and those with chronic schedule adherence problems, allowing the transit operator to optimize the overall schedule. Additionally the data can be extracted to determine ridership, passenger miles and other metrics, and automatically generate any required reports. Routes can be spatially analyzed in a number of ways to identify the busiest or least busy times of day, the most appropriate vehicle for the route or time of day and the most and least productive routes. Spatial analysis using maps would also quickly highlight features that affect the productivity of a given route, such as proximity to areas of employment, social services or community attractions.

For fixed route agencies that also provide ADA or similar paratransit services, a route analysis could assist in identifying areas where fixed routes can replace or supplement demand response services. The optimization process should permit transit operators to identify on-time performance short-falls or unproductive routes and then be able to find ways to resolve the problems by adjusting schedules, headways, vehicles or the routes themselves.

Another example of optimization comes from considering smaller transit operators in smaller regions, such as rural areas. By using the optimization process, existing services can be combined to provide greater efficiency and increase transit availability without the need to increase expenditures in terms of additional vehicles and/or drivers. As a result, a level of transit service can be provided which is substantially greater than that currently available in these types of regions.

For example, many communities use school buses to transport children from their home to school and vice-versa. The buses are in operation for certain time periods in the morning and afternoon and occasionally during other times (field trips, sports teams, etc.). By incorporating the school buses into the optimization system, the transit operator is provided with a variety of ways of increasing service through more efficient use of existing resources. One way is to assign school buses to fixed routes that operate in the time periods when the buses are not required for school use (mid-day, night routes). Another way is to add the school buses to the pool of available paratransit vehicles, to cover peaks in demand or routes within the existing school bus route area. Yet another way is to simply add the school buses to the pool of vehicles, making them available to cover emergencies, breakdowns and similar unexpected situations that would otherwise seriously disrupt service.

### Geography and Demographics

The next consideration for optimization is geography or, more specifically, the division of geographic regions covered by the transit operators along with the demographic data used to describe each region. All but the smallest of operators will be expected to cover more than one region. Depending on the nature of the operator and the regions, travel from one geographic region to another may be built in or may require substantial adjustments. Handling the passenger transfer from one region to another forms a significant component in the optimization process.

A common scenario is that inter-region transportation is covered by one type of vehicle, such as commuter trains for inter-city transit, and transportation within the region is covered by another type of vehicle, such as buses or subways. With this arrangement, passenger transfer from region to region becomes complicated by the additional need to transfer from one type of vehicle to another.

Outlying regions, particularly rural regions, may have limited or restricted service compared to other regions within the network. These types of limitations must be heavily weighted in optimization adjustments. For example, an outlying region which has only one route available has fewer choices for optimization, however, optimization of the connections to the core areas of the transit network become more significant due to the consequences of missing a connection.

To consider the example provided by Vancouver, twelve municipal regions (Vancouver, Burnaby, New Westminster, Richmond, Delta, Surrey, Langley, Coquitlam, Port Coquitlam, Port Moody, Maple Ridge, Mission) are covered by the transit network, with an additional separate bus system for the regions of North Vancouver and West Vancouver.

In these cities, inter-regional travel is common among transit riders and the optimization process must provide an optimal way for riders to travel between regions, considering all other factors presented herein.

The transit operators must also have a clear understanding of the characteristics of the populations they serve and of the relationship between transit services and the social and economic infrastructure of the community as a whole. Demographic analyses rely on data from the Census Bureau, city, state/province, or county agencies to build an accurate picture of the population's age, income, housing, employment, mobility and many other attributes. The optimization process should be able to work with these data, in their myriad forms, to create statistical and spatial information that can be used to profile existing and potential passengers. Population data from the census or a planning model will be aggregations typically covering multiple-block areas (e.g., census blocks, census tracts, or transportation analysis zones). These data may need to be disaggregated into the areas served and not served by transit. The optimization system can do this and can also be used to match individual address data to areas served and not served by transit. Operators can apply statistical demographic data, such as vehicle ownership or population density, to spatial information such as existing bus routes to create a visual snapshot of who is being served in a given area. The planners can also plot census data on a map, overlay bus routes and create buffer areas around those routes to illustrate the demographic make-up of the service area.

Hand-in-hand with the need to incorporate demographics is the need to incorporate location data into the system. Location data describe where physical elements are, including businesses, other transport services, schools, hospitals, social services, daycare facilities and tourist attractions. By combining information about the population with data about where they travel, operators can build on the schedule and ridership knowledge to use the optimization system to create a truly holistic picture of the transit service as it stands and the changes that might be needed in future.

For example, many agencies in the United States are struggling with transit support for Welfare to Work programs. Only about six percent of welfare recipients own vehicles, and recent job growth has been primarily focused in suburban areas. Using GIS tools, planners are able to identify gaps in transit accessibility and estimate the ability of workers to commute to job locations. A recent study in Boston demonstrated that while 99 percent of welfare recipients lived within one-half mile of transit service, only 43 percent of the jobs in the area enjoyed the same proximity. This type of information is readily available and presentable as part of the optimization process, allowing for quicker response to issues and removing the need for expensive external surveys and consulting.

The optimization system provides tools that allow for detailed exploration by selecting points, stops or polygons to more closely analyze the make-up of a specific part of the service area. These data can then be exported as a report or summary or into another application for manipulation. Operators can also create temporary routes, points and polygons to perform scenario analyses on proposed changes, or they can manipulate the demographic data themselves to assess the impact of population changes on the transit service offering.

In addition to evaluating who is using a transit service, demographic analysis is of enormous value to customer information and marketing departments, who must have an in-depth understanding of their audience characteristics in order to provide appropriate information and services. For example, demographic analysis may indicate that a given route serves a particular language group, and that customer service may need to be offered in that language. For marketing departments that are trying to build ridership, a spatial understanding of vehicle ownership, household income and employment can pinpoint where best to focus marketing resources to promote the transit service. At the executive level, these data are also critical.

### Financial Sources

The final consideration for optimization is the financial sources which fund the transit operators. A primary source is rider fares. Another source is government funding, typically from taxes, received from different levels of government. Private funding or charitable funding may also be used, particularly for paratransit services.

Rider fares may be fixed or variable, and can be dependent upon several factors, including the type of vehicle and region of travel, as discussed above. Optimization can be used to determine which potential route is the least expensive for travel from point-to-point. Also, optimization can be used to assess vehicles, routes, and/or regions that generate a low number of rider fares and suggest appropriate adjustments. The optimization process may even be used to suggest fare prices, or changes in the fare system and to assess the potential impact of such changes.

Government funding may be local (city/municipal), regional (state/provincial) or federal, depending on the areas serviced by the network and the policies of the government. Generally, funding would be derived from the government's general tax revenues, however, it is also common to have specific tax levies, such as taxes on property, fuel and vehicle insurance which are intended to directly fund transit networks.

Paratransit operators typically receive private or charitable funding and have specific requirements that must be met for a passenger to be eligible. By using the optimization process to assess patterns with the usage of these networks, if may be possible to combine them with conventional transit networks, and the attendant fare charges, to reduce passenger travel time and increase passenger capacity.

The optimization system can also assess where received funds are being used in the transit network and determine if adequate funds are being received for assigned purposes.

Additionally, received funding may be contingent on ridership, and the effects on ridership resulting from the optimization process must be reflected in the financial aspects of the model.

Financial concerns often have a significant overlap with regional concerns. For example, special transit levies, such as fuel taxes or vehicle insurance taxes may only apply to regions serviced by the transit network. Also, regions with limited or restricted transit service may be exempted from these taxes. Additionally, many transit networks use fare surcharges for travel between regions, and the amount of these charges and the definition of regional boundaries are often contentious issues.

By incorporating these financial considerations, the optimization system can be used to request increased funding based on increased ridership, or to stretch limited funds farther, or a combination of both.

### Optimization

The goal of the optimization process is to increase efficiency of the transit network, with the inherent benefit of increasing ridership. This goal is achieved in several ways. Primarily, the optimization system collects information pertaining to all of the above-listed considerations and generates transit routes for the transit network along with vehicle and driver assignments for these routes. Each consideration is assigned a weight by the party seeking to optimize the network. For example, a priority could be set to maximize inter-regional travel, resulting in increased commuter train service and more inter-regional bus routes, while eliminating other regional bus routes and reducing inter-regional fare surcharges. In general, the result should provide an optimal combination of vehicle capacity, regional service and financial balance.

Another use for the optimization process is to provide an optimized destination-to-destination trip itinerary for any individual passenger subject to any specific limitations requested by that passenger. This way, passengers who want to use the transit network are readily provided with the information necessary to make a conscious and informed decision on how to use the transit network. The optimal itinerary generated can be based on priorities such as lowest fare, fewest transfers or closest transit stops to departure point and/or destination point.

Lastly, the combination of the three considerations set forth above should be continually reviewed to determine which changes must be implemented to achieve the desired goal. Possible changes include fare prices, addition/subtraction of vehicles and the addition/subtraction of routes. Also, the optimization data can be used for future planning, such as building new subway/train stations and extending service to new geographic regions. Finally, optimization allows for improved tracking of riders, which can be used to adjust the funding levels received from government and charitable sources.

For a paratransit network as either part of the whole transit network or as a separate network the optimization process works in the same way. Additionally, with paratransit, the number of riders serviced may be increased by changing the number and types of vehicles and routes available. This may be done by incorporating existing public transit services into the paratransit services where possible.

### Diagrams

As shown in FIG. 1, prior art systems require the passenger (rider, user) to make individual contact with each different aspect of the transit network in order to determine what transit is available and then what transit best meets their needs. Bus routes and times are gathered from the bus network, train stops and times from the train network and so forth. In addition, information must be separately collected from commercial providers, such as airlines, trains and taxis. The collected information, which is generally in different formats, must then be assessed by the user, without any further support. The difficulty of this task is one of the most significant barriers to transit use.

By implementing the optimization system as shown in FIG. 3, all information passes through the system before going to any other aspect of the transit network. The system acts as a central hub for all information gathering, processing and requests.

Bus routes and schedules are received from the bus network, train stops and schedules from the train network, and so forth. Notably, information from other networks is readily incorporated into the whole. Paratransit networks can enter vehicle lists, availability and passenger eligibility criteria. Commercial transit networks, such as airlines, can enter flight schedules or other relevant information. By uniting all this data in one location, a uniformity of content can be provided, which enables uniformity of results when data inquiries are made.

Besides the inherent advantages the system provides for a passenger, there is also a large advantage gained by the transit operators. The accumulation of data allows for greater data analysis and data mining to improve the efficiency of the transit services provided.

At this stage, all of the optimization considerations are set forth. The different types of vehicles and routes available must be considered. Typical optimization factors include overlap between bus route and subway routes, connection times for train arrivals and corresponding bus departures, identification of transfer points where riders must switch vehicles.

Regional issues must be factored in, including the identification of regional boundary zones, specific identification of inter-regional routes and targeting of “hubs”, such as central train stations and subway station, for specific optimization.

Significantly, all those considerations act in concert with one another. For example, inter-regional travel (a geographic consideration) may require an additional fare (a financial consideration) depending on which vehicle and route are used (a routing consideration). If the rider takes an inter-regional commuter train, the additional fare may be built in to the base fare price, although commuter trains typically operate in limited time periods, so additional bus service between regions may also be provided. The bus service may also include passengers who are not traveling between regions, so separate types of fares may be needed.

The optimization process looks at these different considerations and provides results that take all of them into account. In this example, one result might be to reduce the additional inter-regional fare to increase ridership. Alternatively, adding an additional commuter train could reduce demand for inter-regional bus service, allowing those vehicles to be reassigned to other existing or new routes. Another possibility is to modify the boundaries of the regions to increase the scope of regional service. Or all of these optimization suggestions may be combined. These results are derived from incorporating all relevant considerations into the optimization process.

By examining a large range of data, transit operators are able to build a fairly accurate picture of the future. Trends can be incorporated, such as population density decreasing in downtown areas as jobs move further and further into the suburbs; aging populations increasingly dependent on traditional or paratransit services; declining road systems that suffer from near-constant gridlock; etc. Thus, operators can explore the role transit services might play in better adapting to meet the dynamic needs of the public using the subject invention. Demand forecasting and spatial analysis can be used to demonstrate the effects of new bus routes, expanded demand response delivery, route-deviated services, light rail networks or different fare structures.

The optimization process can also help predict which types of service changes will have the most positive affects on ridership. The invention can evaluate proposed routes against a number of criteria. In procuring financial and policy support from all levels of government, transit operators must be able to present a compelling look ahead, and clearly articulate their strategies for dealing with it. The optimization system provides mechanisms for forecasts, analysis and scenario modeling, which in turn allow staff and consultants to spend their time working on the solutions rather than searching for the problem.

An example of the optimization process is readily demonstrated by its application to passenger scheduling and itineraries. The information gathering and processing performed by the optimization process adds several advantages to passenger scheduling that would not otherwise be available. The primary result is that a single passenger scheduling algorithm can be used where previously multiple passenger scheduling algorithms were required

One advantage is that a single algorithm can now be used to handle multiple modes of transport. A user enters a trip request (consisting of origin, destination and desired departure time) and asks the algorithm to suggest possible transit solutions. The algorithm returns a list of possible itineraries that includes paratransit vehicles, fixed route vehicles, flex route vehicles and even taxis and connections to other PTOs and CTOs. With the prior art using different algorithms for different operators, the trip request would have to be directed to each algorithm independently, in some cases requiring that the trip request data be formatted differently. Also, each algorithm would return the results in a different data format, placing a burden on the user interface to try to integrate them all.

The biggest separation between the past algorithms was between the fixed route and variable-route (paratransit) algorithms. Consider using a city's existing itinerary lookup website and requesting directions on how to get from point A to point B. It might tell you to get on a certain bus at route 101, transfer to a different bus at route 400 and so on. With this optimization process behind it, the algorithm can now also suggest potential alternatives such as taking a taxi or a dial-a-ride vehicle instead of, or in combination with, using the fixed route buses. Existing transit algorithms do not provide that degree of integration. This algorithm advances beyond this limitation through the use of the optimization system.

Another advantage arises in the algorithm's ability to generate transfers between vehicles of different types. Not only can it return solutions where each solution uses a different transit type, but it can also return a solution that combines multiple types into one single itinerary. For example, it might suggest a solution where a passenger is picked up by a paratransit bus, taken to a transfer location where they transfer to a fixed route bus, then get off at another transfer point where they transfer to a taxi for the last leg of the trip. This type of solution offers a passenger more choices. For instance, it can allow a passenger to book trips to places where fixed route buses are unavailable while still using the fixed route bus for a portion of the trip. It can also save money because fixed route buses are usually cheaper to use than paratransit buses or taxis. For example, a special needs passenger that cannot walk to a bus stop would traditionally have to take a paratransit bus or taxi from door to door. This service is typically provided by paratransit operators who are heavily subsidized by taxpayers. On long trips, if the paratransit operators can use fixed route buses for part of the trip then they can potentially save money. Backed by the information gathered by the optimization system, the algorithm allows a variable route such as paratransit or taxi to pick the passenger up right where they are and also to drop them off right where they need to go while still using fixed route for portions of the trip in between.

A third advantage gained by using the algorithm is that it unifies the solution costing model across all the types of transport. A solution cost is an abstract number assigned to each potential solution. It is used by the transit operators to help judge which solution is the best choice. It can be based on many factors such as the amount of extra distance added to the vehicles, the number of transfers involved, vehicle load utilization, passenger on-board time and many others. With separate algorithms it is difficult to compare costs for the same trip request because each algorithm has its own way of digesting the multiple cost factors into one single cost. By popular analogy, it was like comparing apples to oranges. However, with all the solutions generated by a single algorithm, it is possible to unify the costing model so that the relative costs of solutions involving different transport modes can be fairly compared, enabling more intelligent selections to be made. To complete the analogy, using the algorithm, comparing a paratransit solution to a fixed route solution is like comparing apples to apples.

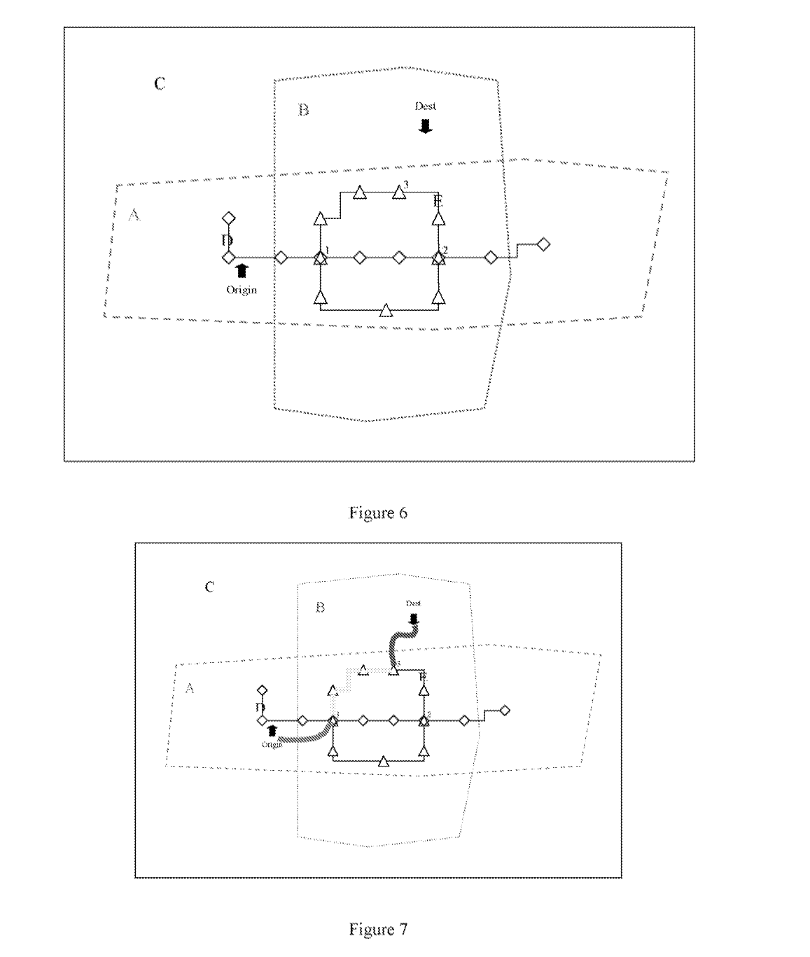

In FIG. 6 five transit services are represented. A is a paratransit service that operates inside the horizontal A polygon. B is also a paratransit service that operates inside the vertical B polygon. C covers the entire city and represents a taxi service's operating area. D is a flex route that moves between the diamond shaped bus stops. E is a fixed route that moves between the triangular stops. All of the 5 services are able to transfer between one another at bus stops 1 and 2 as defined in table 2. A, B and E can transfer between each other at stop 3.

The passenger scheduling algorithm works by dividing the trip solution generation process into several phases. Phase 1 is the discovery of which transit services operate in the vicinity of the trip's origin and destination points. Phase 2 is the discovery of transfer patterns between origin and destination transit services. Phase 3 involves finding times and vehicles for each segment of each transfer pattern found in phase 2. Phase 4 calculates the cost of the valid solutions found in phase 3.

Phase 1 introduces a concept called a transit service. A transit service is an abstraction of all the types of transport that the algorithm supports. A service combines a type of transport with a representation of the area serviced by that type, in effect a combination of the vehicle and route data as well as the geographic and demographic data that has been gathered and analyzed by the optimization system. How the area is defined depends on the type of transport. For a fixed route vehicle, it is defined by the bus stop pattern. A fixed route vehicle always follows a particular path through the city streets. That path can be represented by its bus stop locations connected together in a line. A paratransit vehicle has no fixed stops to define it. Its route is ultimately defined by the trips it is assigned each day and that can vary from day to day. In addition, many of the trips are not assigned until shortly before it pulls out for the day. As a result, the trips on a paratransit bus cannot be used to define a paratransit service because they are not a fixed entity. Like a taxi, a paratransit bus can go anywhere but for practical purposes it is often restricted to certain regions, or zones, of the city. Paratransit and taxi services can therefore be better represented by a polygon that defines their service area rather than by a sequence of pre-determined fixed stops. The passenger scheduling algorithm allows a variable route service to be defined either way—either using the fixed stops assigned to the variable route, or by using a service area polygon assigned to the variable route. This is because a variable route is fundamentally considered as a hybrid between a fixed route bus and paratransit bus.

Phase 1 involves finding all the transit services that operate in the area of the passenger's origin plus all the transit services that operate in the area of the passenger's destination. The services are then sorted, preferably in order of proximity to the actual passenger's location. An alternative way to look at this is that they are sorted in order of how far the passenger would have to walk to use each service. For some modes, like paratransit or taxi, the walking distance is essentially zero because these modes go directly to the passenger's origin or destination point. For services based on stop points the proximity is measured as the walking distance to the nearest bus stop for that service. For services based on polygons, the proximity is based on whether or not the passenger's origin or destination is contained within that polygon. This phase produces a set of from/to service pairs but makes no attempt to choose a vehicle or departure times or to work out a transfer pattern between the services. The transfer pattern is left to phase 2.

Phase 2 is the center of the passenger scheduling algorithm. This phase is where the different types of transport are integrated. Phase 2 accepts the list of from/to services that were produced by phase 1 and then works out transfer patterns between each of those service pairs. Phase 2 uses a recursive algorithm to walk through a transfer table. It can work out all possible ways of transferring between the origin and destination services. The transfer table is set up in advance as part of the optimization process. It allows the passenger to decide which locations are good for making transfers and which services to include or exclude from any particular transfer. However, users do not have to define the complete transfer patterns—only the transfers between two adjacent services. The algorithm in phase 2 then does the rest by dynamically building more complex transfer patterns out of the simple from/to transfer pairs.

In the present example, phase 2 generates coded transfer patterns based on a transfer table. For example, the pattern A-1-E-3-B means: “take service A to stop 1 then transfer to service E which you take to stop 3 where you transfer to service B which takes you to the final destination.” This particular transfer pattern is illustrated by the highlighted lines in FIG. 7 below.

In Phase 3, each pattern must be expanded into a full solution that involves specific vehicles and arrival and departure times. This involves starting with the first service in the pattern and finding all possible vehicles for that service that can pick up the passenger and take them to the next drop-off point. If there is a next service, then the drop-off point will be a bus stop where the transfer takes place and so on down the line. When there is no next service then the drop-off point will be the final destination. The pickup and drop-off times are worked out for each vehicle. When moving on to the next service in the pattern, the pickup time is restricted based on a small transfer window around the previous drop-off. For example, if a vehicle drops a passenger off at a transfer point at 9:00 am, then the vehicle used by the next service to pick them up must do so within the window of 9:00 am to 9:20 am (assuming a maximum allowed layover time of 20 minutes). This window helps to restrict the possible vehicle choices for the services involved in picking up a transfer passenger. The travel time to the stop is then calculated which determines the next drop-off time and so on down the line until the end of the pattern is reached. Once all the services in a pattern have their vehicles and times worked out, then it is becomes a solution and gets added to a list of valid solutions. Sometimes a pattern cannot produce a solution because it does not have any vehicles available at the appropriate time window. In this case the pattern is thrown out. It should be noted that a single transfer pattern can generate multiple solutions because each service can offer multiple vehicles and times to choose from.

Phase 4, the last phase in the passenger scheduling algorithm, accepts the list of valid vehicle/time solutions and then calculates the relative cost of each one. This is where the universal costing formula is applied to all the vehicle types in each solution. The end result of phase 4 is that the list of valid solutions is sorted in order of ascending cost and then presented to the user for selection. The user may choose to select the lowest cost solution or they may choose to re-sort the list based on different criteria i.e. fewest transfers.

### Dispatching

The route planning selection described above can be similarly applied by transit operators when dispatching vehicles and drivers on routes. For fixed routes, it is a relatively straightforward process to assign vehicles and drivers to cover the routes to minimize deadheading and comply with any necessary labor regulations. However, for variable routes, optimization of dispatching is much more difficult. By reviewing the most common requests, both routes and times, for a variable route service, the optimization process may provide alternative solutions for dispatching. For example, larger or smaller capacity vehicles may be used, or additional vehicles added to a route to accommodate the passenger traffic on a route with a minimum of wasted space. Shift changes and break times for drivers can be adjusted to reflect slack periods in service demand.

One use of the optimization process is to reduce personnel expenditures such as overtime by allowing the transit operators to dynamically alter schedules to ensure that each route is covered. Another is the ability to monitor on-board vehicle systems, such as idle monitors, which can also be used as part of driver evaluation processes.

An additional consideration is that drivers can readily access the route system, similarly to passengers, allowing driver input to be more quickly incorporated into the optimization process. Furthermore, driver input can be solicited as a valuable addition to the optimization system's projections by adding driver observations about items such as traffic density, stop locations and similar aspects of the system that can benefit from observer information.

### Passenger Information Services

The passenger information services provided by the optimization system also needs to accommodate new technologies that will, over the long term, need to interface with the system. For example, most information services will soon need to be accessible not just through call centers or PCs, but also to web-enabled cell phones, handheld computers and PDAs, interactive television, or an automated voice response system. The optimization system must allow users to enter not only dates and times of travel and to choose departure locations and destinations by street address intersection, but also to choose locations from a list of common locations such as hospitals, shopping centers or tourist attractions. Other services and priority settings available include: minimizing walking distances, minimizing number of transfers, minimizing travel times, identifying preferred travel mode, identifying ADA routes, clicking on a map to determine departure and arrival locations.

Output options include a basic trip summary with travel time, distance and fares, a detailed written itinerary or even a map with origin, destination and transfer points clearly marked. The system also provides for: return trip planning, street routing, detailed walking instructions, multi-lingual services, multimodal travel information, next bus information, real-time schedule information, and accessibility for passengers with physical or cognitive limitations.

This concludes the description of a presently preferred embodiment of the invention. The foregoing description has been presented for the purpose of illustration and is not intended to be exhaustive or to limit the invention to the precise form disclosed. Many modifications and variations are possible in light of the above teaching and will be apparent to those skilled in the art. It is intended the scope of the invention be limited not by this description but by the claims that follow.

What is claimed is:

1. A system for optimizing the operation of a transit network, said transit network including one or more transit operators, each of said transit operators providing one or more transit vehicles, including: ferries, trains, elevated trains, subways, buses, streetcars, vans and taxis, the system comprising;
a) a data collection component adapted to collect data from said transit operators and said transit vehicles;
b) a data processing component adapted to process said data to determine viable routing options within said transit network for a passenger to travel from a start point to an end point within said transit network;
c) an algorithm for assessing said viable routing options to determine a routing option that minimizes one or more of: fare, time, travel distance, transfers, distance from the start point to entry onto the transit network; distance from the end point to entry onto the transit network or any other passenger-input criteria; and
d) a data display component for presenting the routing option so determined to the passenger.

2. A method of optimizing the operation of a transit network utilizing the system as claimed in claim 1 comprising the steps of;
a) collecting data from said transit operators and said transit vehicles;
b) processing said data to determine viable routing options within said transit network for a passenger to travel from a start point to an end point within said one or more transit networks;
c) analyzing said viable routing options to determine a routing option that minimizes one or more of: fare, time, travel distance, transfers, distance from the start point to entry onto the transit network; distance from the end point to entry onto the transit network or any other passenger-input criteria; and
d) presenting the routing option so determined to the passenger.
